(19) United States
(12) Patent Application Publication
(10) Pub. No.: US 2014/0173333 A1
(43) Pub. Date: Jun. 19, 2014

(54) SEVER AND METHOD FOR HANDLING ERRORS OF PROGRAMS

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HONG FU JIN PRECISION INDUSTRY (ShenZhen) CO.,LTD., Shenzhen (CN); HON HAI PRECISION INDUSTRY CO., LTD., New Taipei (TW)

(21) Appl. No.: 14/064,534

(22) Filed: Oct. 28, 2013

(30) Foreign Application Priority Data
Dec. 17, 2012 (CN) 2012105482393

(51) Int. Cl. H04L 12/24

(52) U.S. Cl. CPC H04L 41/0668
USPC 714/4.11

(57) ABSTRACT

Programs in a host server are the same as programs in a backup server. When the host server is executing handling items in the host server and a system time of the server exceeds an earliest predefined handling time of the handling items, a handling item with the earliest predefined handling time is determined as in error, and a corresponding program in the backup server is executed. When a system time of the backup server exceeds an earliest predefined time of the corresponding program in the backup server and a handling item with the earliest predefined handling time in the backup server is the same as the handling item which is in error in the server, the backup server is switched as a new host server and the host server is switched as a new backup server.

### BACKGROUND

1. Technical Field

Embodiments of the present disclosure relate to program management technology, and more particularly to a server and a method for handling errors of programs.

2. Description of Related Art

When a program needs to handle a plurality of tasks, the program may have to call third-party application. When errors occur in the third-party application, the program may not be able to obtain the errors. Thus the errors in the third-party application causing the program to not being able to handle the tasks.

### BRIEF DESCRIPTION OF THE DRAWINGS

FIG. 1 is a block diagram of one embodiment of a host server including a handling system.

FIG. 2 is a block diagram of one embodiment of function modules of the handling system in FIG. 1.

FIG. 3 is a flowchart of one embodiment of a method for handling errors of programs.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

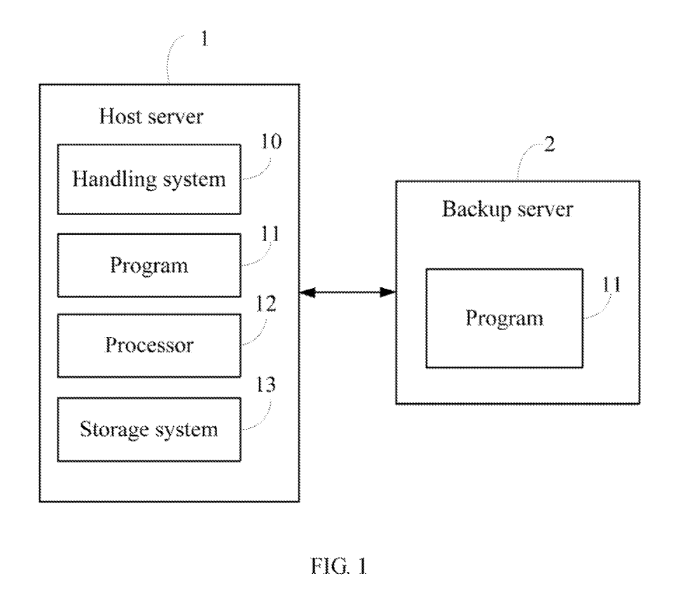

FIG. 1 is a block diagram of one embodiment of a host server 1. The host server 1 includes a handling system 10, a plurality of programs 11 (only one shown), a processor 12, and a storage system 13. The host server 1 connects to at least one backup server 2. The backup server 2 is used to back up the host server 1 when the host server 1 is in error.

The backup server 2 also includes the plurality of programs 11 (only one shown) as included by the host server 1. Each program 11 includes a plurality of handling items. Each handling item corresponds to a predefined handing time. The handling items are queued in sequence according to the predefined handling time of each handling item. When the host server 1 executes a program 11, each handling item of the program 11 is executed at a corresponding predefined handing time. If a handling item of the program 11 is not executed at the corresponding predefined handling time, the program 11 is determined as being in error.

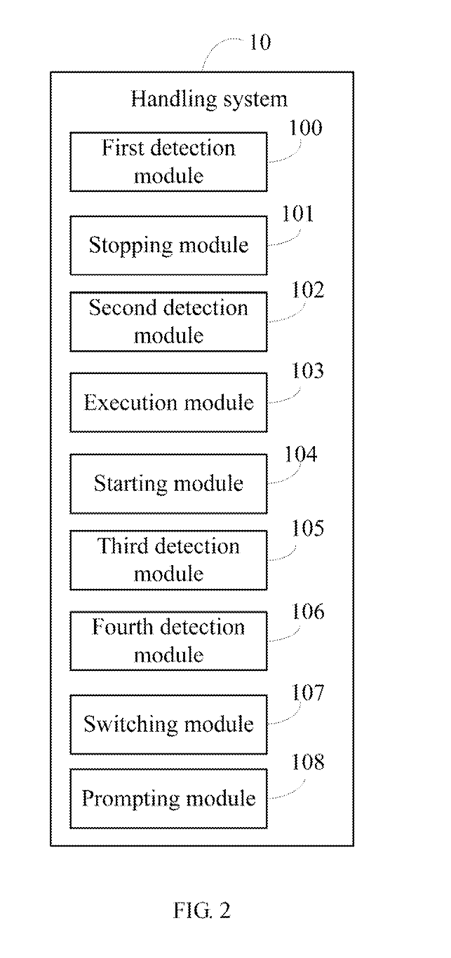

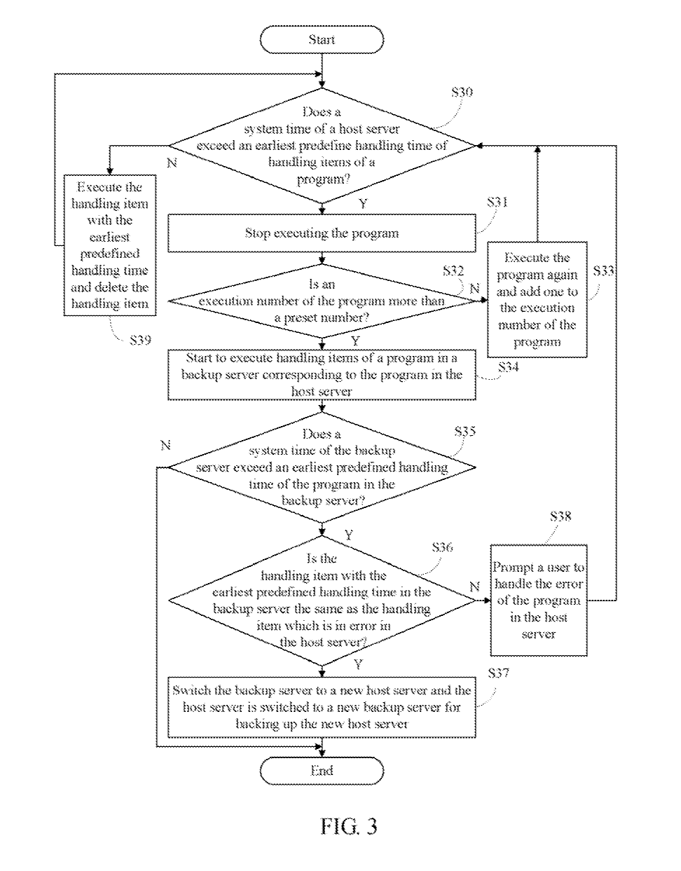

As shown in FIG. 2, the handling system 10 includes a plurality of function modules, such as a first detection module 100, a stopping module 101, a second detection module 102, an execution module 103, a starting module 104, a third detection module 105, a fourth detection module 106, a switching module 107 and a prompting module 108. The modules 100-108 include computerized code in the form of one or more programs that are stored in the storage system 13. The computerized code includes instructions that are executed by the processor 12, to provide functions of the handling system 10. Detailed functions of the modules 100-108 are given in reference to FIG. 3.

FIG. 3 is a flowchart of one embodiment of a method for handling errors of programs. Depending on the embodiment, additional steps may be added, others removed, and the ordering of the steps may be changed.

In step S30, when the host server 1 is executing handling items of a program 11, the first detection module 100 detects whether a system time of the host server 1 exceeds an earliest predefine handling time of the handling items of the program 11. If the system time of the host server 1 exceeds the earliest predefine handling time of the handling items of the program 11, the handling item of program 11 with the earliest predefined handling time is determined as being in error, and step S31 is implemented. If the system time of the server does not exceed the earliest predefined handling time of the handling items of the program 11, in step S39, the first detection module 100 executes the handling item with the earliest predefined handling time, and deletes the handling item after completing executing the handling item. Then the next handling item is taken as the handling item with the earliest predefined handling time.

In step S31, the stopping module 101 stops executing the program 11. In one embodiment, when the program 11 is being executed and related programs of the host server 1 are executed, the stopping module 101 stops executing the related programs simultaneously. For example, if the program 11 is being executed and a Word program is executed at the same time, the stopping module 101 stops executing the program 11 and the Word program simultaneously.

In step S32, the second detection module 102 detects if execution number of the program 11 is more than a preset number. In one embodiment, an initial value of the execution number of the program 11 is “0.” If the execution number of the program 11 is more than the preset number, step S34 is implemented. If the execution number of the program 11 is not more than the preset number, step S33 is implemented.

In step S33, the execution module 103 executes the program 11 again and adds one to the execution number of the program 11. In this embodiment, if the execution numbers of the program 11 in the host server 1 is more than the preset number of the program 11, it indicates that the program 11 in the host server 1 cannot handle the errors of the programs 11 preset number.

In step S34, the starting module 104 starts to execute handling items of the program 11 in the backup server 2 corresponding to the program 11 in the host server 1.

In step S35, the third detection module 105 detects whether a system time of the backup server 2 exceeds an earliest predefined handling time of the program 11 in the backup server 2. If the system time of the backup server 2 does not exceed the earliest predefined handling time of the program 11 in the backup server 2, the handling item of the program 11 in the backup server 2 with the earliest predefined handling time is determined as being normal and the procedure ends. If the system time of the backup server 2 exceeds the earliest predefined handling time of the program 11 in the backup server 2, step S36 is implemented.

In step S36, the fourth detection module 106 detects whether the handling item with the earliest predefined handling time in the backup server 2 is the same as the handling item which is in error in the host server 1. If the handling item with the earliest predefined handling time in the backup server 2 is the same as the handling item which is in error in the host server 1, step S37 is implemented. If the handling item with the earliest predefined handling time in the backup server 2 is not the same as the handling item which is in error in the host server 1, step S38 is implemented.

In step S37, the switching module 107 switches the backup server 2 as a new host server 1 and the host server 1 is switched as a new backup server for backing up the new host server 1. The procedure ends.

In step S38, the prompting module 108 prompts a user to handle the errors of the program 11 in the host server 1, and the procedure returns to step S30.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A host server, comprising:
a processor; and
a non-transitory computer-readable medium that stores one or more programs, which comprise instructions which when executed by the processor of the electronic device, performs operations of:
(a) detecting whether a system time of the server exceeds an earliest predefined handling time of handling items of a program in the server when the server is executing the handling items of the program;
(b) determining a handling item with the earliest predefined handling time as being in error, and stopping executing the program when the system of the server exceeds the earliest predefined handling time of the handling items of the program;
(c) executing the program again when an execution number of the program is not more than a preset number; and
(d) starting to execute handling items of a program in a backup server corresponding to the program in the host server.

2. The server as claimed in claim 1, wherein the operations further comprise:
executing the handling item with the earliest predefined handling time and deleting the handling item in the server when the system time of the server is not exceeding the earliest predefined handling time of the handling items of the program.

3. The server as claimed in claim 1, wherein the operations further comprise:
prompting a user to handle errors of the program in the server when the handling item with the earliest predefined handling time in the backup server is the same as the handling item which is in error in the server.

4. The server as claimed in claim 1, wherein the operations further comprise:
switching the backup server to a new server and switching the server to a new backup server for backing up the new server.

5. The server as claimed in claim 1, wherein the operation (c) comprises:
adding one to the execution number of the program in the server.

6. A method being executed by a processor of a server, comprising steps:
(a) detecting whether a system time of the server exceeds an earliest predefined handling time of handling items of a program in the server when the server is executing the handling items of the program;
(b) determining a handling item with the earliest predefined handling time as being in error, and stopping executing the program when the system of the server exceeds the earliest predefined handling time of the handling items of the program;
(c) executing the program again when an execution number of the program is not more than a preset number; and
(d) starting to execute handling items of a program in a backup server corresponding to the program in the host server.

7. The method as claimed in claim 6, wherein the method further comprises:
executing the handling item with the earliest predefined handling time and deleting the handling item in the server when the system time of the server is not exceeding the earliest predefined handling time of the handling items of the program.

8. The method as claimed in claim 6, wherein the method further comprises:
prompting a user to handle errors of the program in the server when the handling item with the earliest predefined handling time in the backup server is the same as the handling item which is in error in the server.

9. The method as claimed in claim 6, wherein the method further comprises:
switching the backup server to a new server and switching the server to a new backup server for backing up the new server.

10. The method as claimed in claim 6, wherein step (c) comprises:
adding one to the execution number of the program in the server.

11. A non-transitory computer-readable medium having stored thereon instructions that, when executed by a processor of a server, cause the processor to perform operations of:
(a) detecting whether a system time of the server exceeds an earliest predefined handling time of handling items of a program in the server when the server is executing the handling items of the program;
(b) determining a handling item with the earliest predefined handling time as being in error, and stopping executing the program when the system of the server exceeds the earliest predefined handling time of the handling items of the program;
(c) executing the program again when an execution number of the program is not more than a preset number; and
(d) starting to execute handling items of a program in a backup server corresponding to the program in the host server.

12. The non-transitory computer-readable medium as claimed in claim 11, wherein the operations further comprise:
executing the handling item with the earliest predefined handling time and deleting the handling item in the server when the system time of the server is not exceeding the earliest predefined handling time of the handling items of the program.

13. The non-transitory computer-readable medium as claimed in claim 11, wherein the operations further comprise:
prompting a user to handle errors of the program in the server when the handling item with the earliest predefined handling time in the backup server is the same as the handling item which is in error in the server.

14. The non-transitory computer-readable medium as claimed in claim 11, wherein the operations further comprise:
switching the backup server to a new server and switching the server to a new backup server for backing up the new server.

15. The non-transitory computer-readable medium as claimed in claim 11, wherein the operation (c) comprises:
adding one to the execution number of the program in the server.
